(19) United States
(12) Patent Application Publication
(10) Pub. No.: US 2023/0133971 A1
(43) Pub. Date: May 4, 2023

(54) ACCESS CONTROL METHOD, COMPUTER-READABLE RECORDING MEDIUM STORING ACCESS CONTROL PROGRAM, AND INFORMATION PROCESSING APPARATUS

(71) Applicant: FUJITSU LIMITED, Kawasaki-shi (JP)

(72) Inventor: Koichi Onoue, Kawasaki (JP)

(73) Assignee: FUJITSU LIMITED, Kawasaki-shi (JP)

(21) Appl. No.: 17/858,339

(22) Filed: Jul. 6, 2022

(30) Foreign Application Priority Data
Oct. 29, 2021 (JP) 2021-178054

(51) Int. Cl. G06F 21/62

(52) U.S. Cl. CPC G06F 21/6209

(57) ABSTRACT

An access control method is performed by a computer. The method includes: acquiring command line information of a process executed in a container; acquiring a file name of a script to be executed included in the command line information; specifying a path name of a file of the script on the computer that is a host machine, based on the file name of the script; and controlling execution of the script based on the specified path name and a policy related to scripts in the container.

### CROSS-REFERENCE TO RELATED APPLICATION

This application is based upon and claims the benefit of priority of the prior Japanese Patent Application No. 2021-178054, filed on Oct. 29, 2021, the entire contents of which are incorporated herein by reference.

### FIELD

The embodiments discussed herein are related to an access control method, a computer-readable recording medium storing an access control program, and an information processing apparatus.

### BACKGROUND

Containers have been widely used as execution environments for applications in recent years. For example, when using containers, the containers are activated for each user or each application, and the containers share the kernel of the operating system of a host machine. Each container includes an application, middleware used for execution of the application, and a library, and an application is executed in a container.

Japanese Laid-open Patent Publication No. 2017-123011 is disclosed as related art.

### SUMMARY

According to an aspect of the embodiments, an access control method performed by a computer, the method including: acquiring command line information of a process executed in a container; acquiring a file name of a script to be executed included in the command line information; specifying a path name of a file of the script on the computer that is a host machine, based on the file name of the script; and controlling execution of the script based on the specified path name and a policy related to scripts in the container.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating the functional configuration of a host machine according to Embodiment 1;

FIG. 2 is a diagram describing an example of container virtualization;

FIG. 3 is a diagram describing mounting to a container;

FIG. 4 is a diagram describing a problem of script operation in the container;

FIG. 5 is a diagram describing FUSE used in Embodiment 1;

FIG. 6 is a diagram describing an example of a policy;

FIG. 7 is a diagram describing the logical configuration according to Embodiment 1;

FIG. 8 is a diagram describing an example of container information;

FIG. 9 is a diagram describing access control according to Embodiment 1;

FIG. 10A and FIG. 10B are flowcharts illustrating a flow of processing of a control program according to Embodiment 1;

FIG. 11 is a flowchart illustrating a flow of processing of a container runtime according to Embodiment 1;

FIG. 12 is a flowchart illustrating a flow of access control processing for a script according to Embodiment 1;

FIG. 13 is a diagram describing an example of a path of a script file name;

FIG. 14 is a diagram describing the logical configuration according to Embodiment 2; and

FIG. 15 is a diagram describing the hardware configuration of the host machine.

### DESCRIPTION OF EMBODIMENTS

An application in a container may access only files in the same container. For this reason, in order to cause an application in a container to access a file on a host machine outside the container, a directory on the host machine under which the file is saved is mounted to a directory in the container.

However, when a directory on a host machine is mounted to a directory in a container, each script in the same container may access a file and the like in the mounted directory, and there is a concern that security may be lowered.

According to one aspect, an object is to provide an access control method, an access control program, and an information processing apparatus capable of executing access control in units of a script in a container.

Hereinafter, the embodiments of an access control method, an access control program, and an information processing apparatus disclosed in the present application will be described in detail based on the drawings. This disclosure is not limited by the embodiments. The embodiments may be combined with each other as appropriate within the scope without contradiction.

### Embodiment 1

[Functional Configuration]

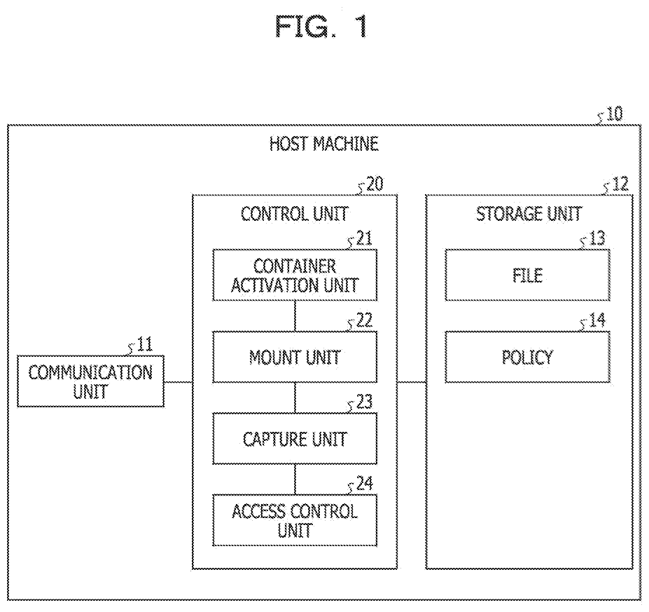

FIG. 1 is a functional block diagram illustrating the functional configuration of a host machine 10 according to Embodiment 1. The host machine 10 illustrated in FIG. 1 is an example of a computer that provides a container environment. Containers have been widely used in recent years because independent execution environments may be easily generated and deleted for each user or each application.

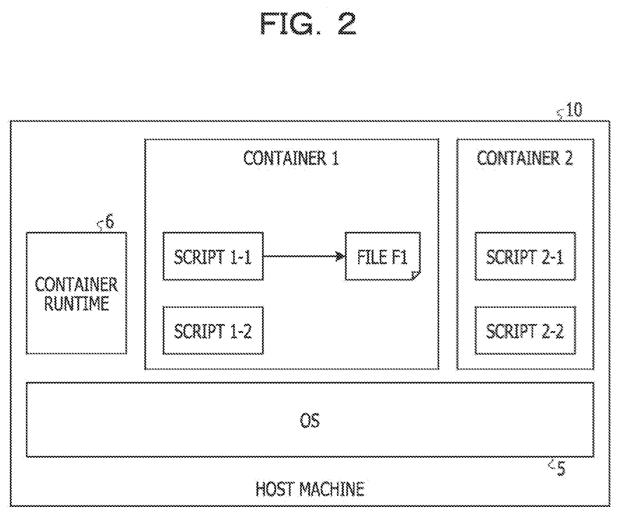

FIG. 2 is a diagram describing an example of container virtualization. As illustrated in FIG. 2, container virtualization is a virtualization technique provided by an operating system (OS). Each container (application container) is activated by a container runtime, and execution spaces of containers are separated from each other. For example, process space, root directory, and the like are different for each execution space, and the same process identifier (ID) or file name in different execution spaces indicate different entities.

In the example of FIG. 2, for example, the host machine 10 executes a Unix®-based OS 5, and a container runtime 6 that activates and manages a container 1 and a container 2 operates on the OS 5. In the container 1, a file F1 is managed, and various applications (hereinafter may be simply referred to as “app”), a script 1-1, and a script 1-2 are executed. In the container 2, various apps, a script 2-1, and a script 2-2 are executed.

Since the execution space of the container 1 and the execution space of the container 2 are separated from each other, the file F1 in the container 1 may not be operated from the app or the script 2-1 of the container 2. For this reason, data on the host machine 10 may not be operated from the app in each container.

Accordingly, in order for an app or a script in a container to use data on a host machine, the mount function of the host machine 10 is used. For example, the mount function of the host machine 10 is used in order to provide data to a container from the outside of the container.

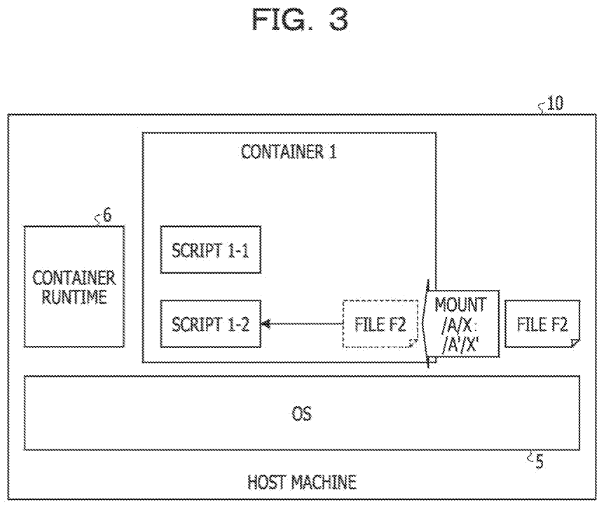

FIG. 3 is a diagram describing mounting to a container. FIG. 3 illustrates an example in which a file F2 on the host machine 10 is mounted to the container 1. As illustrated in FIG. 3, the container runtime 6 executes mounting of the file F2 under the directory “/A/X” on the host machine 10 to the container 1 by storing the file F2 under the directory “/A′/X′” on the container 1. As a result, each app or each script in the container 1 may access the file F2 on the host machine 10 outside the container 1.

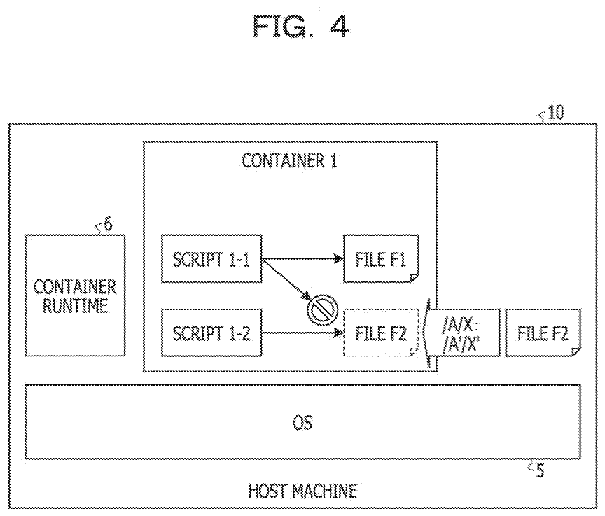

However, the file F2 mounted to the container 1 is shared by the apps and scripts in the container 1. FIG. 4 is a diagram describing a problem of script operation in a container. As illustrated in FIG. 4, the script 1-1, the script 1-2, and the file F1 are arranged in the container 1, and the file F2 is mounted to the container 1. Even in a case where it is desired to permit only the script 1-2 to operate the file F2 in this state, the mounted file F2 may also be operated from the script 1-1.

Accordingly, in Embodiment 1, for example, a filesystem in userspace (FUSE) driver is used in order to achieve access control of access to the mounted file. A FUSE driver is software that captures a system call (open( ) or the like) related to file operation, and a control program is software that controls the operation of a file under a directory to be monitored based on a policy.

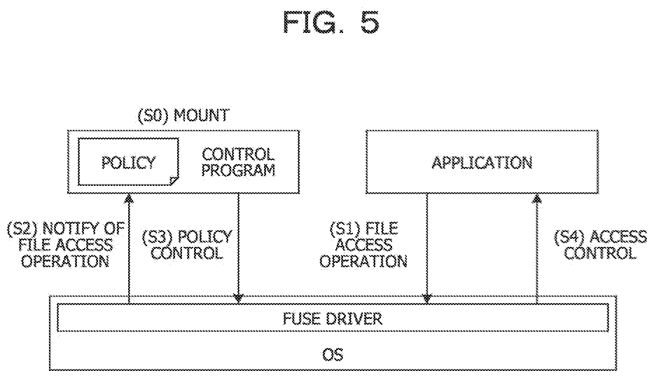

FIG. 5 is a diagram describing FUSE used in Embodiment 1. As illustrated in FIG. 5, the control program mounts a virtual directory for FUSE (for example, /D′) to a directory to be monitored (for example, /D) in order to capture the operation for the directory to be monitored (S0).

When an application executes file access operation (for example, open( )) to the virtual directory (/D′) being subjected to monitoring (S1), the FUSE driver captures the file access operation and notifies the control program of the file access operation (S2).

After that, the control program determines whether to permit or reject the file access operation of the application based on the policy, and notifies the FUSE driver of the determination result (S3). According to the notification from the control program, the FUSE driver controls the file access operation of the application (S4).

The host machine 10 according to Embodiment 1 achieves access control of access to a file mounted to the same container for each script in the same container by controlling file operation from outside the container using the above FUSE driver.

Returning to FIG. 1, the functional configuration of the host machine 10 that achieves access control of access to a file mounted to the same container will be described. As illustrated in FIG. 1, the host machine 10 includes a communication unit 11, a storage unit 12, and a control unit 20.

The communication unit 11 is a processing unit that performs communication with another external device via a network, and is realized by, for example, a communication interface or the like. For example, the host machine 10 may receive a file F1a from an external device at the communication unit 11, and store the file F1a in the storage unit 12.

The storage unit 12 is a processing unit that stores various programs, data, and the like, and is realized by, for example, a memory, a hard disk, or the like. The storage unit 12 stores a file 13 and a policy 14. The storage unit 12 stores an OS program, a container runtime program, a FUSE driver program, programs of various apps in a container, and the like.

The file 13 is a file stored in a directory on an OS, and is a file to be mounted to a container. For example, the file 13 is a file to be subjected to access control of access from each script or the like in a container. The file 13 corresponds to the file F2.

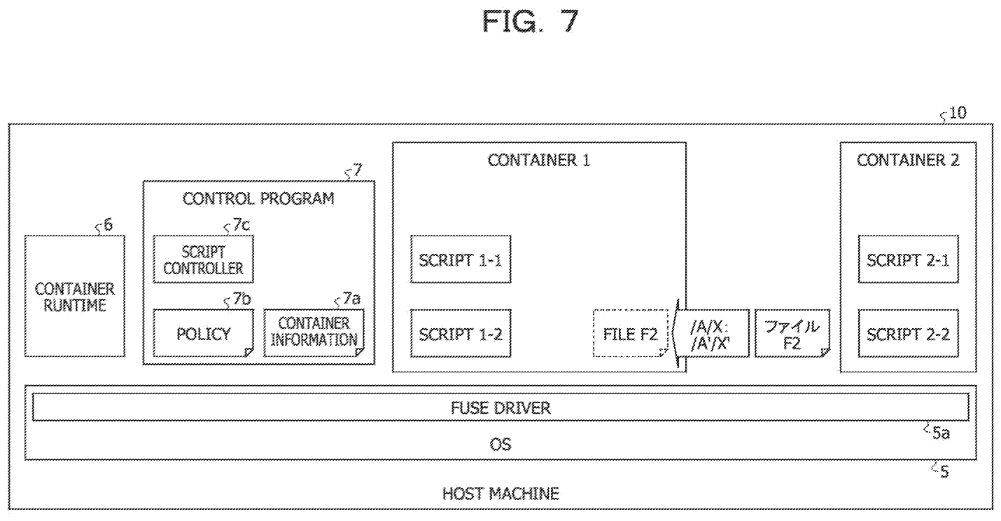

The policy 14 is setting information related to access control. The policy 14 corresponds to a policy 7b in FIG. 7 to be described later. For example, in the policy 14, control contents of access permission or access rejection of access to a directory outside a container are set for each directory outside the container mounted to a directory in the container. In the policy 14, control contents including the name of the container to be controlled, the name of the program to be controlled, and whether writing to a directory outside the container is permitted may be set for each directory outside the container mounted to a directory in the container. In the policy 14, control contents including the path name of a script, a hash value using the path of a script, and whether writing to a directory outside the container is permitted may be set for each script.

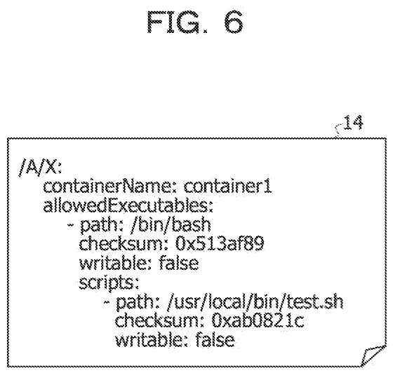

FIG. 6 is a diagram describing an example of a policy. As illustrated in FIG. 6, the policy 14 includes “/A/X” indicating a directory in which a file to be mounted is saved. The policy 14 includes “containerName:” in which the name of a container to which the policy 14 is applied is set, “allowedExecutables:” in which a program capable of accessing a file under a directory to be controlled is set, “path:” in which the path name of the program capable of access is set, “checksum:” in which a hash value corresponding to the path name of the program capable of access is set, and “writable:” in which whether writing to a directory to be controlled is permitted is set.

The policy 14 includes “scripts:” in which a script capable of operation is set, “path:” in which the path name of a script file is set, “checksum:” in which a hash value corresponding to the path of a script file capable of access is set, and “writable:” in which whether writing to a directory to be controlled is permitted is set.

The example in FIG. 6 illustrates access control for a bash shell script in the container 1. “/bin/bash”, which is the execution path name to be captured by a FUSE driver, a hash value (0x513af89) of “/bin/bash”, and writing prohibition (false) are set for a case where the script “/usr/local/bin/test.sh” is executed on a command line. For the path name “/usr/local/bin/test.sh” of the script file, a hash value (Oxab0821c) and writing prohibition (writable: false) are set.

Returning to FIG. 1, the control unit 20 is a processing unit that controls the entire host machine 10, and is realized by, for example, a processor or the like. The control unit 20 includes a container activation unit 21, a mount unit 22, a capture unit 23, and an access control unit 24.

For example, the container activation unit 21 is realized by a container runtime, and executes the function of activating a container in accordance with a command supplied from the communication unit 11 or the like. For example, the mount unit 22 is realized by an OS, and executes the function of mounting a directory to another directory. For example, the capture unit 23 is realized by a FUSE driver, and executes the function of capturing access to a file. For example, the access control unit 24 is realized by a control program, and executes the function of controlling permission and rejection of access to a file.

[Logical Configuration]

Next, the logical configuration in a state where containers are activated on the host machine 10 will be described. FIG. 7 is a diagram describing the logical configuration according to Embodiment 1. As illustrated in FIG. 7, the OS 5 is executed on the host machine 10, and the container runtime 6 and a FUSE driver 5a are executed on the OS 5. A control program 7, the container 1, and the container 2 are executed on the FUSE driver 5a.

The FUSE driver 5a captures access to a file or the like outside a container from a script in the container, and notifies the control program 7 of the access. The FUSE driver 5a receives access control contents for a script in each container from the control program 7, and executes access control for the corresponding script in accordance with the received access control contents.

The container runtime 6 activates a plurality of containers on the OS 5, and manages the activated containers. FIG. 7 illustrates the container 1 and the container 2 that are activated by the container runtime 6. The number of containers activated and managed by the container runtime 6 is not limited to two, and the container runtime 6 may activate and manage three or more containers.

When activating containers, the container runtime 6 executes generation of an execution space of an app, change of a root directory, mounting of a virtual directory for the FUSE driver 5a to a directory to be controlled, and the like. The container runtime 6 notifies the control program 7 of container information that is information related to a container.

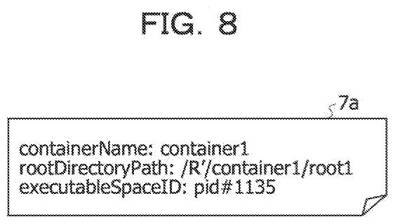

FIG. 8 is a diagram describing an example of container information 7a. As illustrated in FIG. 8, the container information 7a includes “containerName:” in which a container name is set, “rootDirectoryPath:” in which the path name of a root directory of the container on the host machine 10 is set, and “executableSpaceID:” in which an ID for identifying an execution space or the like is set. In the example of FIG. 8, for the container 1, “/R/container1/root1” is set as the path name of a root directory, and execution space ID “pid #1135” is set. Preferably, information set in “containerName:” matches the container name in order to associate the list of programs capable of operation with the container information. An execution space ID set in “executableSpaceID:” is information that may be acquired by the control program 7, and is an ID that uniquely identifies a container. For example, a PID namespace ID, a Mount namespace ID, and the like in Linux® namespaces correspond thereto.

By using the FUSE function, the control program 7 acquires setting related to the execution environment of a container from the container runtime 6, acquires information related to command line execution from the /proc file system, and controls the file operation of a script in the container based on the policy including the list of scripts for which operation is permitted. The control program mounts the directory on the host machine 10 set in the policy 7b to the virtual directory for the FUSE driver 5a.

The control program 7 includes the container information 7a, the policy 7b, and a script controller 7c. The container information 7a is information notified from the container runtime 6. For example, the container information 7a is information illustrated in FIG. 8. Access control for each script is set in the policy 7b. For example, the policy 7b is information illustrated in FIG. 6. The script controller 7c executes access control for each script in accordance with the policy 7b.

The container 1 is a container activated by the container runtime 6. In the container 1, a plurality of apps are executed, and the script 1-1 and the script 1-2 are executed. The file F2 on the host machine 10 is mounted to the container 1. For example, the file F2 under the directory “/A/X” on the host machine 10 is mounted to the container 1 by the file F2 being stored under the directory “/A′/X′” on the container 1.

The container 2 is a container activated by the container runtime 6. In the container 2, a plurality of apps are executed, and the script 2-1 and the script 2-2 are executed.

[Example of Processing of Access Control]

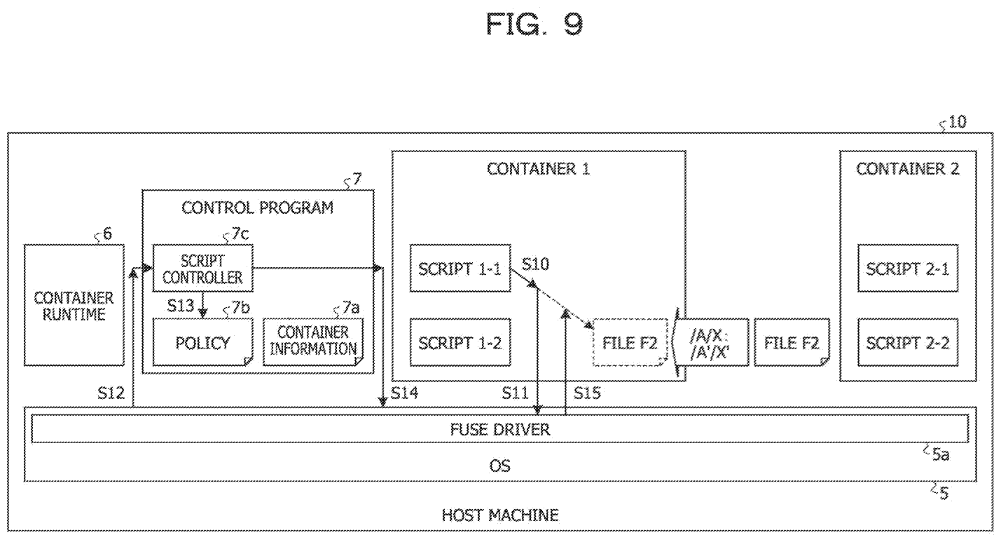

Access control in units of a script in the above-described state will be described. FIG. 9 is a diagram describing access control according to Embodiment 1. As illustrated in FIG. 9, when the script 1-1 is executed and attempts to access the file F2 (S10), the FUSE driver 5a captures (hooks) this access (S11) and notifies the control program 7 of capture information including the name of the script that has performed the access, the file name of the access target, and the like (S12).

Next, the script controller 7c of the control program 7 specifies the “name of the script that has performed the access and the file name of the access target” included in the notified capture information, refers to the policy 7b, and determines whether access control may be performed (S13). For example, the script controller 7c determines whether access control may be performed depending on whether the target script 1-1 is registered in the policy 7b, whether the contents of access by the script 1-1 is writing operation, whether the path name of the file of the script 1-1 or the hash value of the path name matches the policy 7b, and the like.

The script controller 7c notifies the FUSE driver 5a of a result of determination of whether access control may be performed (S14). After that, the FUSE driver 5a executes access control of access to the file F2 by the script 1-1 according to the result of determination of whether access control may be performed notified by the script controller 7c (S15).

[Overall Flow of Processing]

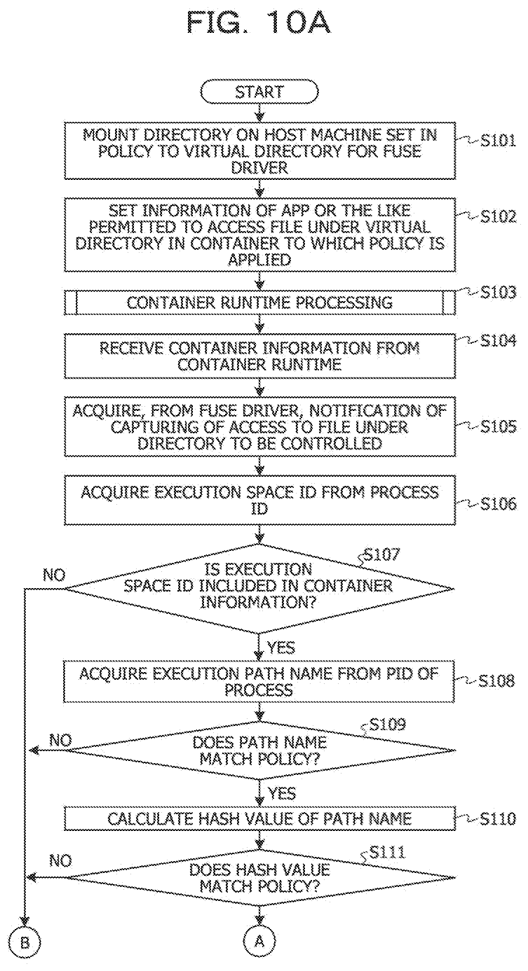

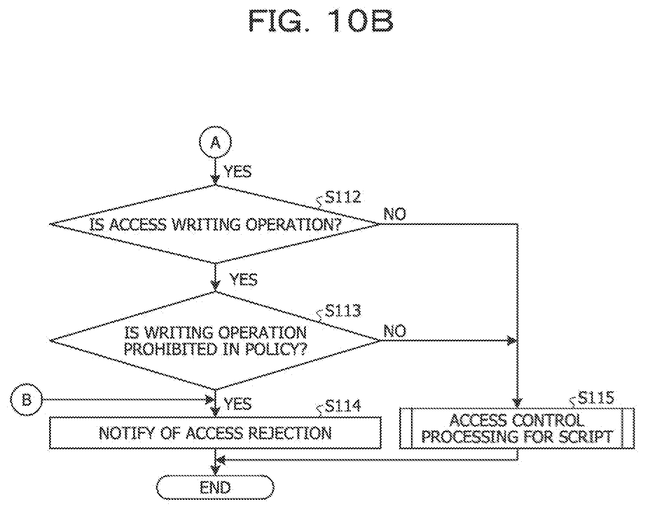

FIG. 10 is a flowchart illustrating a flow of processing of the control program 7 according to Embodiment 1. As illustrated in FIG. 10, the control program 7 mounts the directory on the host machine 10 set in the policy 7b to the virtual directory for the FUSE driver 5a (S101). For example, in accordance with the policy 7b illustrated in FIG. 6, the control program 7 mounts the directory of the path “/A/X” described in the first line of the policy 7b to the virtual directory for a FUSE driver FD of which path is “/A′/X′”.

Next, the control program 7 sets information of a program or the like permitted to access the file F2 under the virtual directory, in the container 1 to which the policy 7b is applied (S102). For example, the control program 7 executes setting of program information operable under the FUSE mount point “/A′/X′”.

After that, when container runtime processing by the container runtime 6 is executed (S103), the control program 7 receives container information from the container runtime 6 (S104). For example, the control program 7 receives the container information illustrated in FIG. 8.

Next, the control program 7 acquires, from the FUSE driver 5a, a notification of capturing of access to the file under a directory to be controlled (S105). Based on the process ID included in the acquired notification, the control program 7 acquires the execution space ID of the container in which access to the file F2 under the directory to be controlled is performed (S106). For example, the control program 7 acquires the execution space ID from “/proc/PID/ns/pid”, which is a symbolic link to the namespace (PID namespace) of the process ID. “PID” is a process ID of an app that performs access to a file. As described above, when a program in the container 1 accesses the file under the directory to be controlled, the control program 7 acquires the execution space ID of the container 1.

The control program 7 determines whether the execution space ID is included in the container information (S107). For example, the control program 7 acquires the container information 7a related to the container 1 in step S104, and when the execution space ID acquired in step S106 is the execution space ID of the container 1, determines that the acquired execution space ID is included in the acquired container information 7a.

When the acquired execution space ID is not included in the container information 7a (S107: No), the control program 7 notifies of access rejection of access to the file F2 under the directory to be controlled (S114). For example, the control program 7 notifies the program or the like of access rejection via the FUSE driver 5a (S114).

On the other hand, when the acquired execution space ID is included in the container information 7a (S107: Yes), the control program 7 acquires an execution path name of the program or the like that performs access to the file under the directory to be controlled (S108). For example, the control program 7 acquires, from the process ID of the program or the like that performs access to the file under the directory to be controlled, an execution path name that is the path name of the program or the like in the container. The control program 7 is notified of the process ID (PID) in a host process space from the FUSE driver 5a, and may acquire an execution path name from this PID by referring to “/proc/PID/exe” that is a symbolic link to the execution path. For example, “PID” is a process ID of a program that performs access to a file. The control program 7 acquires an execution path name “/bin/bash” for a program (bash shell script) of the container 1 that performs access to the file F2 under the directory to be controlled.

When the acquired execution path name is not registered in the policy 7b (S109: No), the control program 7 executes S114. For example, the control program 7 notifies the program corresponding to the execution path name of access rejection of access to the file F2 under the directory to be controlled.

On the other hand, when the acquired execution path name is registered in the policy 7b (S109: Yes), the control program 7 reads the file of the execution path name and calculates the hash value of the corresponding program (S110).

When the hash value of the program is not registered in the policy 7b (S111: No), the control program 7 executes S114. For example, the control program 7 notifies the program corresponding to the execution path name of access rejection of access to the file F2 under the directory to be controlled.

On the other hand, when the hash value of the program is registered in the policy 7b (S111: Yes), the control program 7 determines whether the access to the file under the directory to be controlled is writing operation (S112).

When the access to the file under the directory to be controlled is writing operation (S112: Yes), the control program 7 determines whether writing operation to the file under the directory to be controlled is prohibited in the policy 7b (S113). For example, in a case where the writing control information (writable) associated with the path name acquired in step S108 is “false” in the policy 7b, the control program 7 determines that writing operation is prohibited.

When writing operation is prohibited (S113: Yes), the control program 7 executes S114. For example, the control program 7 notifies the program corresponding to the execution path name of access rejection of access to the file F2 under the directory to be controlled.

On the other hand, when it is determined in S112 that the access to the file under the directory to be controlled is not writing operation (S112: No) or when it is determined in S113 that writing operation is not prohibited (S113: No), the control program 7 executes access control processing for a script (S115).

[Processing of Container Runtime]

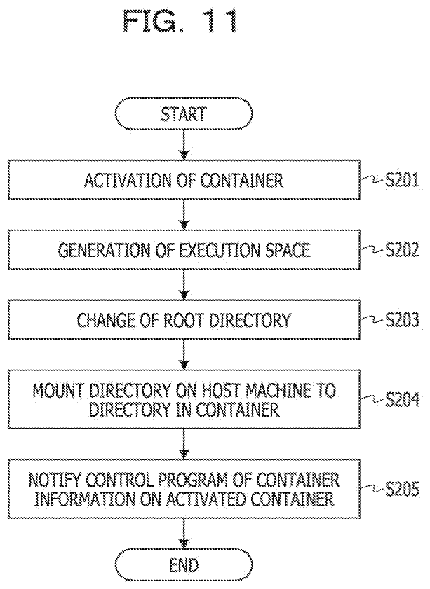

FIG. 11 is a flowchart illustrating a flow of processing of the container runtime 6 according to Embodiment 1. The processing of the container runtime is the processing executed in S103 of FIG. 10.

As illustrated in FIG. 11, the container runtime 6 executes activation of containers in accordance with a supplied command (S201). Next, the container runtime 6 executes generation of an execution space (S202), change of a root directory (S203), and processing of mounting a directory on the host machine 10 to a directory in the container (S204), and notifies the control program 7 of the container information 7a related to the activated container (S205).

For example, in a case where the activated container is the container 1, the virtual directory for the FUSE driver 5a of which path is “/A′/X′” is mounted to the directory to be controlled of the container 1 of which path is “/B/Y”. Since the directory (/A/X) on the host machine 10 storing the file F2 is mounted to the virtual directory, the file F2 is provided under the directory to be controlled as a result of the mounting of the virtual directory. Next, the container runtime 6 notifies the control program 7 of container information on the activated container. As described above, in a case where the activated container is the container 1, the container information 7a illustrated in FIG. 8 is notified to the control program 7, and the notified container information 7a is acquired by the control program 7 in S104 of FIG. 10.

[Access Control Processing for Script]

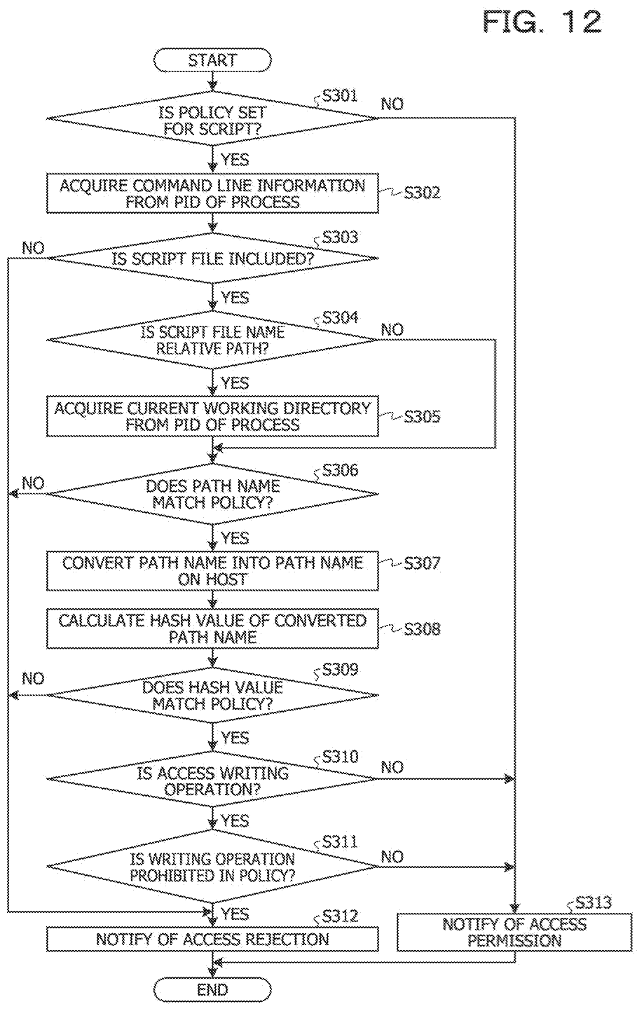

FIG. 12 is a flowchart illustrating a flow of access control processing for a script according to Embodiment 1. The access control processing is the processing executed in S115 of FIG. 10.

As illustrated in FIG. 12, the script controller 7c of the control program 7 determines whether a policy is set for an executed script (S301). For example, the script controller 7c determines that a policy is set for a script when various information is set for “scripts:” in the policy 7b.

When a policy is not set for a script (S301: No), the script controller 7c notifies of access permission (S313). For example, the script controller 7c notifies a program or the like (script) of access permission via the FUSE driver 5a.

On the other hand, when a policy is set for a script (S301: Yes), the script controller 7c acquires command line information from the PID of a process (S302). For example, the script controller 7c acquires command line information at the time of executing a command line program from “/prpc/PID/cmdline”, which is the PID of an executed process. PID is a process ID (PID) in a host process space, and is notified from the FUSE driver 5a to the script controller 7c.

Next, the script controller 7c determines whether a script file name is included in the command line information (S303). When a script file name is not included (S303: No), the script controller 7c notifies the program or the like (script) of access rejection via the FUSE driver 5a (S312).

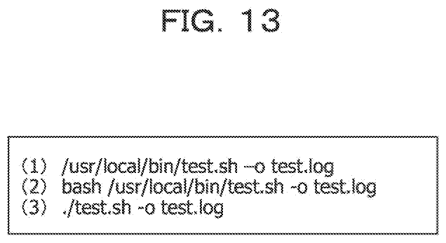

On the other hand, when a script file name is included (S303: Yes), the script controller 7c determines whether the script file name included in the command line information is a relative path (S304). FIG. 13 is a diagram describing an example of a path of a script file name. Each path name illustrated in FIG. 13 indicates a path name acquired from command line information (/prpc/PID/cmdline), and is an execution file name of a bash script “test.sh”. The path name illustrated in (1) of FIG. 13 is an example of a path name indicated by an absolute path, and path names illustrated in (2) and (3) of FIG. 13 are examples of path names indicated by a relative path. The execution path name of the program “/bin/bash” is acquired by the control program 7 and permitted by the policy 7b as described with reference to FIG. 10.

When the script file name included in the command line information is a relative path (S304: Yes), the script controller 7c acquires the current working directory, which is the directory being executed, from the PID of the process (S305). For example, the script controller 7c acquires a working directory from “/prpc/PID/cwd”, which is the PID of the executed process. When the script file name is not a relative path (S304: No), S306 is executed without executing S305.

Next, the script controller 7c determines whether a path name is registered in the policy 7b (S306). For example, in a case where the script illustrated in (2) or (3) of FIG. 13 is executed, since the path names of (2) and (3) are relative paths, the script controller 7c acquires “/usr/local/bin” from “/proc/PID/cwd”, converts the relative path into “/usr/local/bin/test.sh”, and determines whether “/usr/local/bin/test.sh” is included in the policy 7b.

When a path name is not registered in the policy 7b (S306: No), the script controller 7c notifies the program or the like (script) of access rejection via the FUSE driver 5a (S312).

On the other hand, when a path name is registered in the policy 7b (S306: Yes), the script controller 7c converts the path name into a path name on the host by using the path name of a root directory of the container information 7a (S307). For example, when the path name in the container 1 is “/usr/bin/script1” and the path name of a root directory is “/R/container1/root1”, the script controller 7c converts the path name into “/R/container1/root1/usr/bin/script1”.

The script controller 7c reads the file of the converted path name, calculates a hash value of the corresponding script (S308), and determines whether the hash value is registered in the policy 7b (S309).

When the hash value is not registered in the policy 7b (S309: No), the script controller 7c executes S312. For example, the script controller 7c notifies of access rejection of access to the file F2 under the directory to be controlled for the script corresponding to the execution path name.

On the other hand, when the hash value is registered in the policy 7b (S309: Yes), the script controller 7c determines whether the access to the file under the directory to be controlled is writing operation (S310).

When the access to the file under the directory to be controlled is writing operation (S310: Yes), the script controller 7c determines whether writing operation to the file under the directory to be controlled is prohibited in the policy 7b (S311). For example, in a case where the writing control information (writable) associated with the path name is “false” in the policy 7b, the script controller 7c determines that writing operation to the file F2 is prohibited.

When writing operation is prohibited (S311: Yes), the script controller 7c executes S312. For example, the script controller 7c notifies of access rejection of access to the file F2 under the directory to be controlled for the script corresponding to the execution path name.

On the other hand, when it is determined in S310 that the access to the file under the directory to be controlled is not writing operation (S310: No) or when it is determined in S311 that writing operation is not prohibited (S311: No), the script controller 7c permits access control for a script (S313). For example, the script controller 7c notifies the script corresponding to the execution path name of access permission of access to the file F2 under the directory to be controlled via the FUSE driver 5a.

### Effects

As described above, the control program 7 operating outside a container may control the file operation of a script in the container based on the policy 7b including the list of scripts for which operation is permitted.

For example, in a known technique, in a case where it is desired to control file access to a bash shell script (/usr/local/bin/test.sh), setting of whether to permit or not to permit all bash scripts is performed. For example, in a case where “/usr/local/bin/test.sh” is executed on a command line, since the execution path name acquired at the time of capturing by FUSE is “/bin/bash”, it is not possible to permit only “/usr/local/bin/test.sh”.

By contrast, in the host machine 10 according to Embodiment 1, the control program operating outside a container may acquire setting related to the execution environment of the container, acquire information related to command line execution from the/proc file system, and control the file operation of a script in the container while using the FUSE function, based on the policy 7b including the list of scripts for which operation is permitted. Accordingly, the host machine 10 may control the file access of the script “/usr/local/bin/test.sh” while controlling the file access of the execution path name “/bin/bash”.

### Embodiment 2

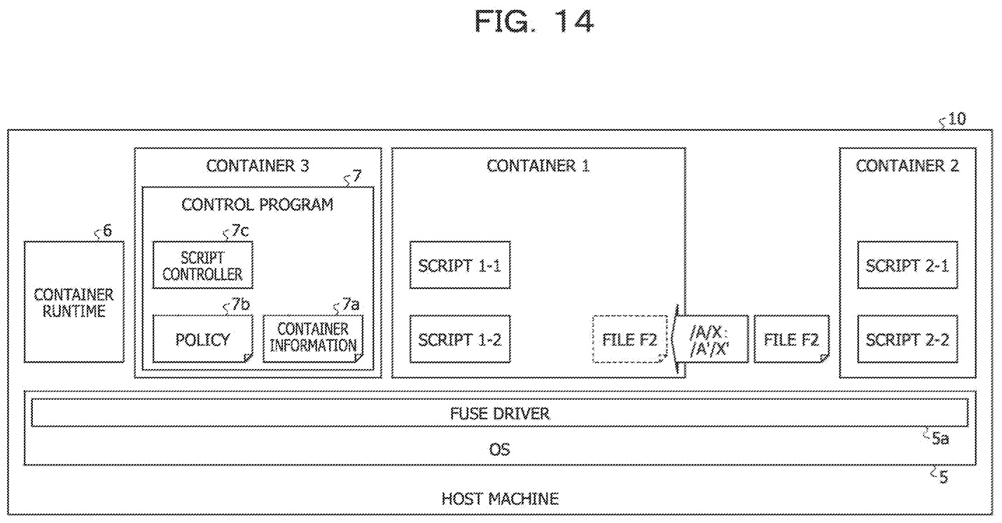

Controlling the file operation of a script may also be achieved by a container of the control program 7. FIG. 14 is a diagram describing the logical configuration according to Embodiment 2. FIG. 14 is different from FIG. 7 of Embodiment 1 in that a container 3 is provided. The control program 7 is executed in the container 3, and the control program 7 includes the container information 7a, the policy 7b, and the script controller 7c.

To realize the logical configuration of FIG. 14, activation of the container 3 including the control program 7 is performed by the container runtime 6 in addition to the processing in Embodiment 1. For example, when generating an execution space, the container runtime 6 sets the process space ID to be the same as that of the host machine 10. This is to enable the process information in an application container (container) to be acquired from “/proc”.

The container runtime 6 changes a root directory and executes mount processing. For example, the container runtime 6 mounts a root directory, of directories on the host machine 10 to be mounted to the FUSE driver, to a directory in a container. The container runtime 6 mounts a root directory, of directories on the host machine 10 as mounting destinations in the FUSE driver 5a, to a directory in a container, the root directory among a group.

For example, the container runtime 6 mounts the root directory (/A) on the host machine 10 to the root directory (/Z) in the container 3. The container runtime 6 mounts the root directory (/A) on the host machine 10 to the virtual directory (/A′) of the FUSE driver 5a corresponding to the root directory on the host machine 10. The container runtime 6 mounts the virtual directory (/A′) of the FUSE driver 5a corresponding to the root directory on the host machine 10 to the virtual directory (/Z′) of the FUSE driver 5a corresponding to the root directory in the container 3. The container runtime 6 sets the Mount propagation option to be shared. This is for transferring the FUSE mount point generated in the container 3 to the host machine 10 and the app container. The directory (/R) on the host machine 10 including the root directory of the app container is mounted to the root directory (/R′) of the app in the container 3.

Although directories change, subsequent processing to be executed by the control program 7 in the container 3 is basically similar to the processing in Embodiment 1, and thus detailed description will be omitted. As described above, the host machine 10 according to Embodiment 2 may also control access to a file for each script in a container in a case where a script in the container accesses a file under a mounted directory outside the container. For this reason, files outside the container may be made secure. As described above, the control program 7 is executed in the container 3. Accordingly, since a script in a container may not be related to the control program 7, access permission or access rejection of access to a file outside the container may not be controlled by the script itself. Accordingly, files outside the container may be made secure.

### Embodiment 3

While embodiments of the present disclosure have been described, the present disclosure may be implemented in various different forms other than the above-described embodiments.

[Numerical Values and the Like]

The number of containers, format of policies, name of directories, name of files, and the like used in the above embodiments are merely examples and may be changed optionally.

[System]

The processing procedures, control procedures, specific names, and information including various types of data and parameters described and illustrated in the above specification and drawings may be changed optionally unless otherwise specified.

The function of each component of each device illustrated in the drawings is conceptual, and the components do not have to be configured physically as illustrated in the drawings. For example, the specific form of distribution or integration of each device is not limited to that illustrated in the drawings. For example, the entirety or a part thereof may be configured by being functionally or physically distributed or integrated in an arbitrary unit according to various types of loads, usage states, or the like.

All or arbitrary part of the processing functions performed in each device may be realized by a CPU and a program analyzed and executed by the CPU or may be realized as hardware using wired logic.

[Hardware]

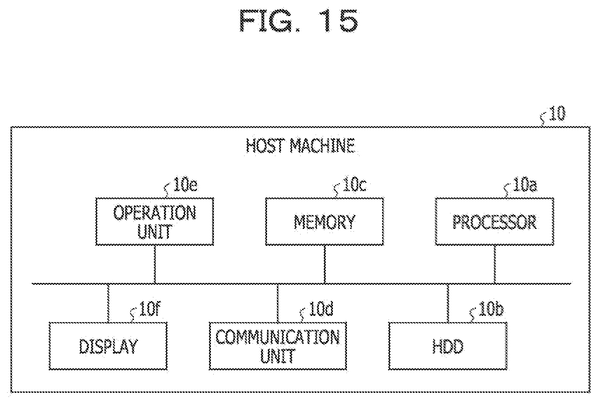

FIG. 15 is a diagram describing the hardware configuration of the host machine 10. As illustrated in FIG. 15, the host machine 10 includes a processor 10a, a hard disk drive (HDD) 10b, a memory 10c, a communication device 10d, an operation unit 10e, and a display 10f. The units illustrated in FIG. 15 are coupled to one another by a bus or the like.

The communication device 10d is a network interface card or the like, and performs communication with other devices. The operation unit 10e corresponds to a keyboard, a mouse, a touch panel, or the like. The display 10f corresponds to a liquid crystal display or a touch panel. The HDD 10b stores a program for operating the functions illustrated in FIG. 1 and a database.

The processor 10a operates a process of executing the functions described in FIG. 1 and the like by reading, from the HDD 10b or the like, a program that executes processing similar to the processing executed in each processing unit illustrated in FIG. 1, and loading the program into the memory 10c. For example, in this process, the functions similar to the function of each processing unit included in the host machine 10 are executed. For example, the processor 10a reads, from the HDD 10b or the like, a program having a function similar to those of the container activation unit 21, the mount unit 22, the capture unit 23, the access control unit 24, and the like. The processor 10a executes a process of executing processing similar to the processing of the container activation unit 21, the mount unit 22, the capture unit 23, the access control unit 24d, and the like.

As described above, the host machine 10 operates as an information processing apparatus that carries out an access control method by reading and executing a program. The host machine 10 may also realize the functions similar to those of the above embodiments by reading the above program from a recording medium by a medium reading device and executing the above read program. A program referred to in this other embodiment is not limited to being executed by the host machine 10. For example, the present disclosure may be applied in a similar manner in a case where another computer or server executes a program or a case where the computer and the server execute a program in cooperation with each other.

The program may be distributed via a network such as the Internet. The program may be recorded on a computer-readable recording medium such as a hard disk, a flexible disk (FD), a compact disc read-only memory (CD-ROM), a magneto-optical (MO) disk, or a Digital Versatile Disc (DVD), and may be executed by being read out from the recording medium by the computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An access control method performed by a computer, the method comprising:
acquiring command line information of a process executed in a container;
acquiring a file name of a script to be executed included in the command line information;
specifying a path name of a file of the script on the computer that is a host machine, based on the file name of the script; and
controlling execution of the script based on the specified path name and a policy related to scripts in the container.

2. The access control method according to claim 1,
wherein in the specifying,
specifying an absolute path as the path name when the file name of the script is designated by the absolute path, and
converting a relative path into an absolute path by using a name of a directory that is being executed and specifying the converted absolute path as the path name when the file name of the script is designated by the relative path.

3. The access control method according to claim 1,
wherein the policy is information in which control contents of access permission or access rejection of access to a directory outside a container are set for each directory outside the container mounted to a directory in the container, and
wherein in the controlling, controlling access from the script to the directory in accordance with the control contents in which the specified path name is defined in the policy.

4. The access control method according to claim 3,
wherein the policy is information in which the control contents that include a name of a container to be controlled, a name of a program to be controlled, and whether writing to a directory outside the container is permitted are set for each directory outside the container mounted to a directory in the container, and
wherein in the controlling, controlling access from the script to a directory outside the container in accordance with the control contents defined in the policy, in a case where a name of the container and a program for activating the process are set in the policy, and writing to the directory by the program is permitted in the policy.

5. The access control method according to claim 4,
wherein the policy is information in which the control contents that include a path name of a script, a hash value that uses a path of the script, and whether writing to a directory outside the container is permitted are set for each of the scripts, and
wherein in the controlling, permitting writing from the script to the directory outside the container when the specified path name is registered in the policy, a hash value of the specified path name matches a hash value registered in the policy, and writing to a directory outside the container is permitted in the policy.

6. A non-transitory computer-readable recording medium storing an access control program for causing a computer to perform a process comprising:
acquiring command line information of a process executed in a container;
acquiring a file name of a script to be executed included in the command line information;
specifying a path name of a file of the script on the computer that is a host machine, based on the file name of the script; and
controlling execution of the script based on the specified path name and a policy related to scripts in the container.

7. An information processing apparatus comprising:
a memory, and
a processor coupled to the memory and configured to perform a process including:
acquiring command line information of a process executed in a container;
acquiring a file name of a script to be executed included in the command line information;
specifying a path name of a file of the script on the computer that is a host machine, based on the file name of the script; and
controlling execution of the script based on the specified path name and a policy related to scripts in the container.
